(19) United States
(12) Patent Application Publication
(10) Pub. No.: US 2005/0210531 A1
(43) Pub. Date: Sep. 22, 2005

(54) Method for monitoring access to content by a terminal, a terminal, user rights server, distribution automation, supplier server, data medium and system associated therewith

(76) Inventor: Christian Bertin, Rennes (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/504,669

(22) PCT Filed: Feb. 4, 2003
(86) PCT No.: PCT/FR03/00338

§ 371 Date: May 10, 2005

(30) Foreign Application Priority Data
Feb. 15, 2002 (FR) 02/01972

(51) Int. Cl. H04N 7/16

(52) U.S. Cl. 725/143

(57) ABSTRACT

A method for controlling access to a content by a terminal, comprising splitting (20b) the content into a first and a second part, storing (21) the first part in the terminal (1), saving (23) the second part in a memory located on a medium (2) outside the terminal (1), connecting (24a) the medium (2) to the terminal (1), and reconstituting (25a) the content by combining the two parts.

This present invention concerns a method for controlling access to a content by a terminal as well as a terminal, a content operating-rights server, an automatic distributor of second parts of content, a supplier server of parts of content, a data medium and a system for implementation of the process.

Some television channels transmit programmes, also called content, to receivers, while controlling access by these receivers to the programmes distributed. A known method of access control to the distributed content consists of scrambling the content and communicating one or more unscrambling keys to the receivers authorised to receive this content. There exist different implementation variants of this access control method.

A first variant consists of breaking down the content into packets of data, marking the packets using either an even indicator or an odd indicator, and scrambling the packets marked by the even indicator using a first scrambling key and the packets of data marked by the odd indicator using a second scrambling key which is different from the first.

The distributed content can be broken down into several data streams. For example, for each type of audio and video data, a content can be broken down into a basic data stream, and into one or more additional data streams intended to improve the quality of the signal conveyed by the basic stream. Each receiver can thus adapt the quality of the received signal to its own capabilities, by using the basic stream and one or more additional streams where appropriate. In this event, a second variant for implementation of the process of access control to the distributed content consists of scrambling only one of the streams, such as the basic audio stream, so as to downgrade the sound quality of the audio component of the content. Only those receivers with the correct key are able to play the audio component of the content with optimal sound quality.

A third variant consists of breaking down the content into an elementary data stream, whose restoration leads to a discernible, but not directly usable, component of the content, and into a additional data stream that allows a full restoration of the content, and scrambling the additional stream only.

These different methods of access control to the content consist of protecting the content by scrambling all or part of the content. However the totally or partially scrambled contents are exposed to the risk of piracy and fraudulent copying.

The technical problem of the invention is therefore to propose a process to control access to a content by a terminal which allows the risk of piracy and fraudulent copying to be limited.

This problem is solved by the fact that the process includes the following stages, designed:
to split the content into a first part and a second part;
to store the first part in the terminal;
to save the second part in a memory located on a medium which is external to the terminal;
to connect the said medium to the terminal and
to reconstitute the content by combining the two parts.

The first part of the content, stored in the terminal, does not, on its own, allow the content to be restored correctly. In order to restore the content, the terminal must retrieve the second part of the content from the external medium and then combine the two parts of the content.

In one particular embodiment of the invention, the values of bytes of the content are read off in a random manner, and the read-off values of these bytes are recorded in the memory of the medium, forming the second part of the content, and their respective positions in the content. Such a method of byte sampling is suitable for all type of coding.

In a variant, the values of bytes of the content are read off in a targeted manner, and the read-off values of the bytes are recorded in the memory of the medium, forming the second part of the content, and their respective positions in the content. Such a byte sampling method allows the essential bytes of the original content to be read off in such a manner as to disrupt the latter in a predictable manner.

In order to obtain the first part of the content, it is possible to delete the bytes whose values have been read off or to modify the values of the bytes read off.

Advantageously,
a holder of the said medium acquires operating rights for the content and
before reconstituting the content from the two content parts, the validity of the operating rights are verified, and reconstitution of the content is authorised only if the operating rights are valid.

Thus, in order to reconstitute the content, the terminal must not only have access to the memory medium storing the second part of the content, but the operating rights for the content attributed to the holder of the medium must also be valid. These operating rights for the content can consist, for example, of a period of usage or in a number of uses. The granting of operating rights for the content to the terminal allows the risks of piracy to be reduced even more.

Advantageously, a network address of a operating-rights server is saved in the memory of the medium and, in order to verify the validity of the operating rights, the terminal connects to the rights server over the network.

Advantageously again, the terminal retrieves the first part of the content in accordance with one of the following methods:
by downloading of the first part from an information site over a network of the IP type,
by reading the first part on an external medium,
by reception of an electronic message containing the first part of the content.

It is preferable that the medium be introduced into an automatic distributor, which records the second part of the content in the memory of the medium.

In a variant, the second part of the content is saved in the memory of the medium at the end of manufacture of the said medium.

The invention also concerns a terminal for implementation of the process described above, including the means to acquire a first part of a content, the means for reading an external memory medium and the means to reconstitute the said content by combination of the first part of the content and a second part of the content extracted from the memory of the external medium.

The invention also concerns a content operating-rights server for the implementation of the process described previously, including a user database containing, for each user, user identification data and operating rights for the user associated with a given content, the means for connection to a network and the means for authorisation of use, arranged, on receipt of a request from a user terminal, so as to verify the validity of the operating rights for the said user associated with a content in order to authorise or interdict the use of the said content.

The invention also concerns an automatic distributor of second content parts, for implementation of the process described previously, including the means for acquisition of second content parts, the resources for a man-machine interface arranged to allow a user to select one of the second content parts, and the means to save the second part of selected content in a memory of an external memory medium.

The invention also concerns a server supplying first and second content parts, for implementation of the process described previously, including a content database containing a multiplicity of content and the means to split each content of the base into a first and a second content part, and the means to send the said first and second parts.

The invention also concerns a data medium for implementation of the process described previously, intended to contain a part of a content, used to reconstitute the said content.

The invention finally concerns a system for implementation of the process described previously, including
a supplier of content parts located in a first network, and intended to split the content into a first and a second part;
at least one automatic distributor, intended to receive second content parts transmitted by the said supplier over the first network, and to distribute the second content parts, stored on data media, to users and
at least one content reading terminal, intended to store the first part of a content, to read an external data medium in order to extract from it the second part of the said content, and to combine the first and the second parts of the content in order to reconstitute the said content.

The invention will be better understood using the following description of a particular method of implementation of the process to control access to a content by a terminal, and of a particular form of implementation of the different devices or arrangements for the implementation of the process in accordance with the invention, with reference to the appended diagrams in which:

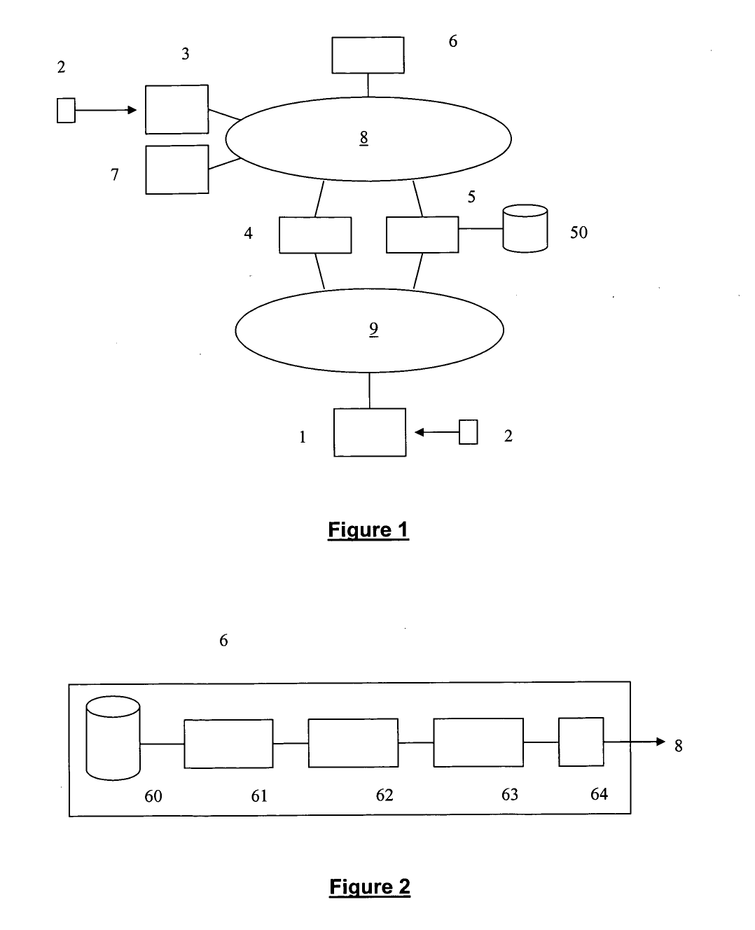

FIG. 1 represents a view of the system of the invention;

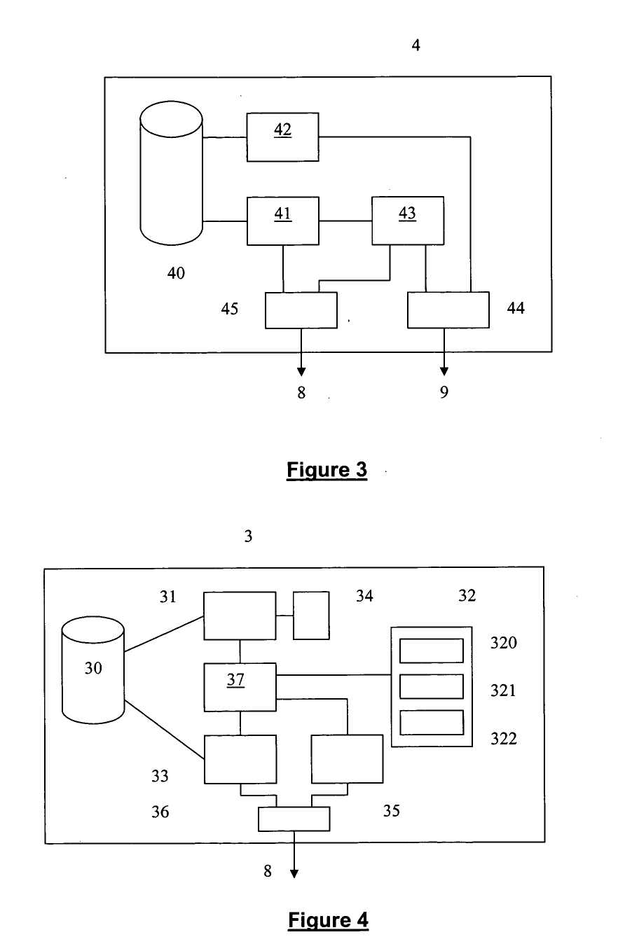

FIG. 2 represents a functional block diagram of a supplier of reduced content and associated extracted contents from FIG. 1;

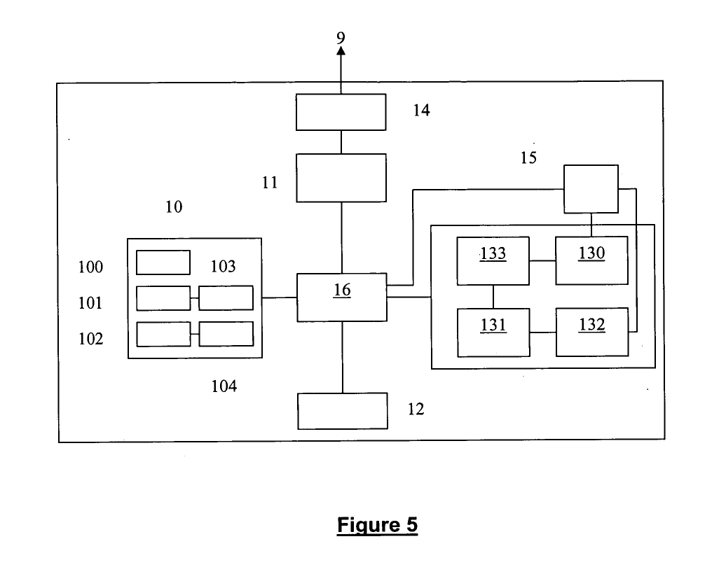

FIG. 3 represents a functional block diagram of a content operating-rights server from FIG. 1;

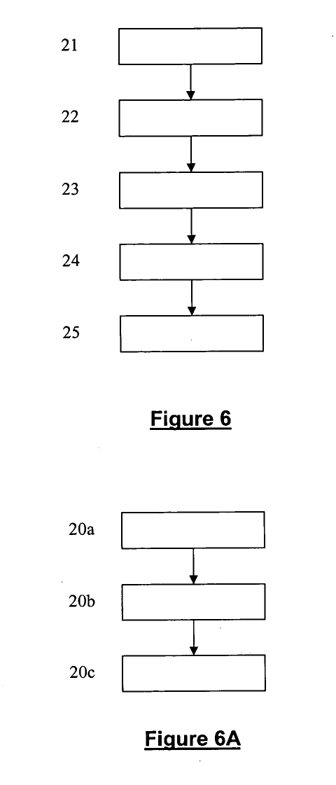

FIG. 4 represents a functional block diagram of an automatic distributor of extracted contents from FIG. 1;

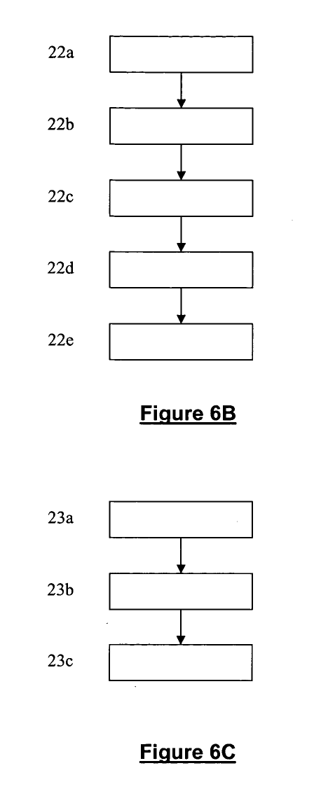

FIG. 5 represents a functional block diagram of the terminal from FIG. 1;

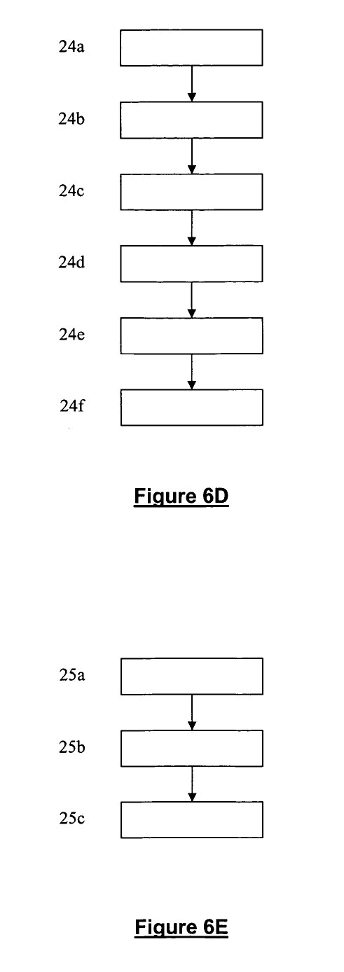

FIGS. 6 and 6A to 6E represent flow charts of the different stages of the process.

The system shown in FIG. 1 includes a content reading terminal (1), a memory medium (2), in this case a smartcard, a supplier server (6) of reduced content and of extracted contents, an automatic distributor (3) of extracted contents, a server (4) of operating rights for content, a Web site (5) for distribution of reduced content, a centre (7) for authorisation of payment, and two networks, here one network of the IP private type (8) and one of the Internet type (9). For reasons of clarity, FIG. 1 shows only a single automatic distributor (3) and a single terminal (1). However, the system preferable includes a number of automatic distributors and a number of reading terminals.

The supplier server (6) of reduced content and of associated extracted contents includes a content database (60), a scrambling module (61), a content-splitting module (62), a transmission module (63) and a connection module (64) to the IP private network (8).

Straight away, it can be seen that an identification reference is attributed to each content.

The content database (60) contains a multiplicity of contents and, for each content, the identification reference of this content, descriptive information on this content, a scrambling key, and a corresponding unscrambling key. The descriptive information on a content contains the title of the content, its period, a summary, information on the people associated with this content (director, actors, producer, etc.) and other information of such a nature as to interest a potential consumer of the content.

The splitting module (62), linked to the database (60) and to the transmission module (63), is intended to split the database content (60) into a first and a second part, which are respectively called “reduced content” and “extracted content”. The operation of “splitting” a content consists of reading off the values of bytes of this content, by locating the respective positions of these bytes. The bytes whose values are read off are here chosen in a random manner. These bytes are here deleted from the original content. All of the bytes read off form the extracted content while the original content, having “shed” the bytes read, constitutes the reduced content.

The scrambling module (61), interposed between the database (60) and the splitting module (62), is intended to scramble the content using the scrambling key stored in the database (60) and to supply the corresponding unscrambling key to the transmission module (63).

The transmission module (63), linked to the connection module (64) to the IP network (8), is intended to transmit
the reduced content to the Web site (5) and
the associated extracted contents with, for each extracted content, the unscrambling key of the original content and the respective positions of the bytes of the original content whose values have been read off, to the automatic distributor (3).

The automatic distributor (3) includes a local database (30), a saving module (31), a man-machine interface assembly (32), an extracted contents acquisition module (33), a smartcard slot (34), a connection module (35) to the rights server (4) and a connection module (36) to the IP private network (8). All these elements are connected to a central unit (37) which controls the operation of the automatic distributor (3).

The database (30) contains extracted contents and, for each of these extracts, the identification reference of the original content (that is of the content from where the extract is taken), descriptive information relating to this content, the respective positions in the original content of the bytes read and forming the extracted content, and the unscrambling key of the original content. The database (30) could be external to the automatic distributor (3).

The man-machine interface assembly (32) includes a input keyboard (320), a display screen (321) and a man-machine interface application (322) allowing a user to view on the screen (321) a list of the content for which extracts are stored in the database (30), and to select one contents from this list in order to control the saving of the corresponding extract in the memory of a card placed in the slot (34).

The saving module (31), linked to the database (30), is intended to extract from the database (30) the extract of a content selected by the user using the MMI application (322), the respective positions in the original content, bytes whose values have been read off and which form this extracted content, as well as the identification reference and the unscrambling key of the original content, and to save all this information in a smartcard placed in the slot (34).

The acquisition module (33), linked to the database (30) and to the IP private network (8) by means of the connection module (36), is intended to acquire the extracted contents and information relating to this content (identification reference, descriptive information and positions in the original content of the bytes read), from the supplier (6) over the IP private network (8). When the supplier (6) receives new content, it so informs the automatic distributor (3). The latter then connects to the supplier (6) and retrieves the extracts of the new content. In a variant, the automatic distributor (3) could connect regularly to the supplier (6) in order to retrieve the extracts of the new content. In accordance with another variant, the automatic distributor (3) could have no database. In this event, for each extracted content requested by a user, the automatic distributor would connect to the supplier (6) in order to retrieve the requested extracted content.

The connection module (35) to the rights server (4), linked to the IP connection module (36), allows the automatic distributor (3) to connect to the rights server (4) and thus to put the holder of a smartcard (2) in contact with the operating-rights server (4) in order to enable the holder of the card (2) to acquire operating rights for a content.

The server (4) is intended to supply, to users, operating rights that are associated with content. A right to use a content is here composed of a predetermined period of use, during which the holder of the operating right can freely use the content. In a variant, the operating right could be a predetermined number of uses, that is of restorations of the content. The server (4) includes a user database (40), a module (41) for management of the database (40), a use authorisation module (42), a transaction module (43), an Internet connection module (44) and a module (45) for connection to the IP private network (8).

For each user, the user database (40) contains an identifier and a confidential user code as well as any operating rights for the user associated with one or more contents, with the identification reference of the content or contents concerned.

The use authorisation module (42), linked to the database (40) and to the Internet connection module (44), is intended to verify the validity of operating rights for users associated with content, in order to authorise or interdict the use of this content by these users.

The transaction module (43) is linked to the Internet (9) by means of the Internet connection module (44), and to the IP private network (8) by means of the interface (45). This module (43) is intended to perform transactions for the purchase of operating rights for content by users.

The management module (41) is linked to the database (40), to the connection module (45), and to the transaction module (43). This module (41) records, modifies and deletes information in the database (40), taking account in particular of information supplied by users, by means of the transaction module (43), and regularly updates the operating rights for the users in the database (40).

The Web site (5), hosted by an Internet server (9), is linked to a database (50) containing a multiplicity of reduced content and, for each reduced content, the identification reference of the original content and the descriptive information of the content (title, period, summary, etc.) on the basis of which the users can choose whether or not they wish to acquire this content. The site (5) is arranged so as to present, to visitor terminals, a list of the content for which reduced contents are stored in the database (50) and, for each of these contents, the corresponding descriptive information (title, summary, period, etc.), and to allow the terminals to obtain a copy of this reduced content.

The reading terminal (1) includes a man-machine interface (10), an internet browser (11), a smartcard reader (12), a content reader (13), an internet connection module (14), a reduced-content storage memory (15) and central control unit (15).

The man-machine interface (10) includes an input keyboard (100), a viewing screen (101) and a sound generating device (102). The screen (101) and the equipment (102) are connected to two digital/analogue (DAC) converters (respectively 103 and 104) intended to convert the video data and the audio data into a video signal and an audio signal.

The Internet browser (11), linked to the Internet connection module (14), allows the terminal (1) to navigate on the Internet, and in particular to connect to Web sites.

The card reader (12) is arranged to receive and to read smartcards.

The content reader (13) includes a module (130) for the acquisition of reduced content, a module (131) for the control of reading, a module (132) for the reconstitution and decoding of the content and a man-machine interface module (133).

The acquisition module (130), linked to the memory (15), is intended to acquire reduced content by downloading it from the Web site (5) using the browser (11), and storing this reduced content in the memory (15).

The control module (131), linked to the reconstitution and coding module (132) and to the man-machine interface module (133), is intended to trigger the reading of a content after first performing certain checks, as will be explained later.

In view of the restoration of a content by the terminal (1), the module (132) is intended to reconstitute the content concerned by combination of the corresponding reduced content, stored in the memory (15), and the extract of the content stored in the smartcard placed in the reader (12), and then to unscramble and decode the reconstituted content. The operations of combination, unscrambling and decoding are executed here by a single application, so that it is extremely difficult to gain access from the outside to the intermediate result of each of these operations. In a variant, the three operations (reconstitution, unscrambling and decoding) could be executed by one single-block hardware element. One single-block module could also execute the operations of combination, unscrambling, decoding and digital/analogue conversion of the audio data and/or video data. This same module could also execute the restoration operation on the audio and/or video signal.

The man-machine interface module (133), linked to modules 130 and 131, allows to a user:
to acquire operating rights for a content from the rights server (4);
to control the downloading of a reduced content from the Web site (5) and saving of the latter to the memory (131) and
to control the reading of a content from a reduced content stored in the memory (131), and of an extracted content stored on a smartcard.

All the elements of the terminal (1) are linked to the central unit (15), intended to control the operation of the terminal (1).

A card distributor, namely an automatic distributor or a specialist vendor, provides a user with the smartcard (2) which contains:
an identifier and a confidential user code as well as
the URL location address on the Internet (9) of the content operating rights server (4).

The identifier and the confidential user code are transmitted in parallel to the server (4) and stored in the user database (40) of the latter.

The process to control access to a content by the terminal (1) will now be explained, with reference to FIGS. 6 and 6A to 6E.

With reference to FIG. 6A, for each content stored in the database (60), the supplier (6) scrambles the content using the scrambling key stored in the database (60) (stage 20a), splits it into a reduced content and a additional extracted content (stage 20b) and sends the reduced content and the associated extracted content respectively to the Web site (5) over the Internet (9), and to the automatic distributor (3) over the IP private network (8) (stage 20c). To split the content (stage 20b), the supplier (6) reads off the values of bytes of the original content, here in a random manner, and identifies the position of each of these bytes. The bytes whose values have been read off are here deleted from the original content. During stage 20c, the supplier (6) sends a reference identification, and the descriptive information on the original content, to the Web site (5), together with the reduced content, and sends the positions of the bytes read in the original content forming the extract as well as the reference identification, the unscrambling key and the descriptive information on the original content, to the automatic distributor (3), together with the additional extracted content.

The stages aiming to acquire and restore a given content (C₁), using the terminal (1), will now be described. By definition, we will describe as “C_{1R}” and “E_{C1}” the reduced content and the extract of the content (C₁) respectively.

In stage 21, the terminal (1) acquires the reduced content (C_{1R}) by downloading it from the Web site (5). To this end, using the browser (11), the terminal (1) connects to the Web site (5) which provides it with a list of the reduced contents available. Under the control of a user, the terminal (1) selects the reduced content (C_{1R}) and sends to the site (5) a request for acquisition of the reduced content (C_{1R}) selected. On receipt of this request, the site (5) sends to the terminal (1), over the Internet 9, the protected (that is scrambled) selected reduced content, (C_{1R}), the reference identification of the original content (C₁), and the descriptive information on this content (C₁). The protected reduced content (C_{1R}), as well as the reference identification and the descriptive information on the content (C₁), are stored in the memory (131). The protected reduced content (C_{1R}) thus acquired cannot be used on its own to restore the original content (C₁), even after unscrambling. In order to restore the original content, the terminal (1) must retrieve the additional extracted content (E_{C1}).

In stage 22, the holder of the smartcard (2) acquires operating rights for the content (C₁) from its terminal (1). To this end, with reference to FIG. 6B, in stage 22a, the holder of the card (2) inserts the latter in the reader (12) of the terminal (1) and thus connects the memory of the card (2) to the terminal (1). In stage 22b, under the control of the holder of the card, the terminal (1) connects to the URL address of the server (4), extracted from the smartcard (2), and in stage 22c, sends the server (4) a request for the purchase of operating rights for the content (C₁). This request contains the identifier and the confidential user code, extracted from the smartcard (2), as well as the reference identification of the content (C₁). In stage 22d, the server (4), in cooperation with the payment authorisation centre (7), effects the transaction and then attributes the required operating rights to the holder of the card (2). In stage 22e, the server (4) saves the operating rights of the user, associated with the content (C₁), in its database (40). Instead of acquiring operating rights associated with the content (C₁) by connecting to the rights server (4), over the Internet (9), from its terminal (1), the holder of the smartcard (2) could acquire operating rights for content from the rights server (4), by means of the automatic distributor (3), over the private network (8).

Stage 23 consists of saving the extracted content (E_{C1}) to the smartcard (2). To this end, with reference to FIG. 6C, in stage 23a, the user who is the holder of the card (2), inserts the latter into the slot (34) of the automatic distributor (3) and, in stage 23b, selects the extracted content (E_{C1}) from a list of extracted contents displayed by the automatic distributor (3) on its screen (321). In stage 23c, the automatic distributor (3) saves to the smartcard (2) the extracted content (E_{C1}) selected, the respective positions in the content (C₁) of the bytes whose values have been read off, forming the extracted content (E_{C1}), the reference identification of the corresponding original content (C₁), the unscrambling key of this content (C₁) and, where appropriate, descriptive information relating to the content (C₁). It will be noted here that stage 23 for saving of the extracted content (E_{C1}) to the smartcard (2) can be effected before stage 21 for acquisition of the reduced content (C_{1R}). At this stage, the smartcard (2) therefore contains:
the identifier and the confidential code of the holder of the card (2),
the URL address of the rights server (4),
the reference identification of the content (C₁),
the unscrambling key of the content (C₁),
the extract of the content (C₁),
the respective positions of the bytes whose values have been read off, forming the extracted content, in the content (C₁) and
where appropriate, descriptive information relating to the content (C₁).

Since stages 21, 22 and 23 are independent of each other, they can therefore be implemented in any order, unless the saving of an extracted content to the smartcard (2) is subordinated to the prior purchase of operating rights, in order to limit the risk of fraud.

In stage 24, under the control of module 131, terminal 1 carries out checks before restoring the content (C₁).

To this end, with reference to FIG. 6D, in stage 24a, the user again connects his smartcard to the terminal (1), by inserting it into the card reader (12) and, in stage 24b, orders the reading of the content (C₁) whose extract (E_{C1}) is contained in the memory (131). In stage 24c, the terminal (1) verifies that the reference identification associated with the reduced content (C_{1R}) stored in the memory (15) is identical to that associated with the extracted content (E_{C1}) stored in the memory of the card (12). In the event of a match between the two reference identifications of content (or in other words in the event of correspondence between the reduced content (C_{1R}) stored in the terminal (1) and the extracted content (E_{C1}) stored in the smartcard (2), in stage 24d, the terminal (1) connects to the rights server (4) over the Internet (9) and sends it a request for the purpose of obtaining an authorisation for the reading or the use of the content (C₁). This request contains the reference identification of the content (C₁) as well as the identifier and the confidential code of the user holding the card 2. In stage 24e, the server (4) looks in the database (4) for the operating rights for the user of the terminal (1), using the identifier and the received confidential user code, and verifies that the terminal (1) is in possession of valid operating rights associated with the content (C₁) and, if so, determines the remaining authorised period of use. In stage 24f, the server (4) authorises reading of the content (C₁) by the terminal (1), by the transmission of a notification of authorisation for the use of the content, indicating remaining authorised period of use. On receipt of this authorisation, in stage 24g, the terminal (1) triggers the reading of the content (C₁).

In stage 25, the terminal (1) reads the content (C₁). To this end, with reference to FIG. 6E, in stage 25a, the reconstitution and decoding module (132) i) combines the reduced content (C_{1R}), stored in the memory (15), and the extracted content (E_{C1}), stored in the memory of the card (2), using the indication of the respective positions in the original content (C₁) of the bytes read off contained in the smartcard (2), ii) in stage 25b, unscrambles the content (C₁) reconstituted using the unscrambling key extracted from the smartcard (2), and iii) in stage 25c, the terminal (1) restores the content (C₁), or in other words displays the video component of the content (C₁) on the screen (101) and distributes the audio component of the content (C₁) using the sound equipment (102).

In addition, the terminal (1) regularly verifies the validity of the operating rights for the terminal (1) associated with the content (C₁), by calculating the remaining period of use of the content (C₁), using a chronometer within the terminal (1) (not shown). After expiry of the received remaining authorised period of use, the terminal (1) inhibits the reading of the content.

In the event of interruption of the operation of the terminal (1) before the end of the authorised period of use, the terminal (1) must reconnect to the rights server (4) and again ask it for an authorisation to use the content (C₁).

In the above description, the terminal (1) acquires the reduced content by downloading it from a Web site (5). In a variant, one could envisage that the terminal (1) acquires the reduced content (C_{1R}) in accordance with one of the following methods:
by reading the reduced content (C_{1R}) from an external medium such as a CD-ROM, or
by receipt over the Internet of an electronic message containing the reduced content (C_{1R}).

For each extracted content requested by a user, the automatic distributor (3) could provide the user with a memory medium containing the desired extracted content and the information relating to the original content (positions of the bytes read, reference identification, and unscrambling key), instead of saving these data to the personal smartcard of the user. In this event, the automatic distributor could save, in the memory medium, the identifier and the confidential code of the user, supplied by the latter or, in a variant, the user could enter his identifier and his confidential code into the reading terminal. The extracted content could be recorded in the memory medium at the end of manufacture of the said medium.

The automatic distributor (3) could also distribute CD-ROMs or other types of data media, containing reduced content.

The content need not be scrambled, with splitting of the content itself allowing access to the content to be controlled.

Inversely, one could also scramble the extracted content, that is the values of bytes read off and the respective positions of these bytes in the original content. In this event, one could save the corresponding unscrambling key to the smartcard 2.

Instead of integrally retrieving the reduced content before the stage of reconstitution of the original content, the terminal could acquire the reduced content in “streaming” mode, that is in real time as required, from a Web site, and then reconstitute, unscramble, decode and restore the content in real time, as the reduced content is received.

Instead of reading off the values of bytes in a random manner from the original content, one could read off the values of bytes chosen in a targeted manner, so as to read off the essential bytes. In this way, the content is disrupted in a more reliable manner.

Also, instead of deleting the bytes whose values have been read off in the original content, one could modify them by changing their values.

In the above description, the automatic distributor (3) directly retrieves the extracted contents from the supplier (6). In a variant, the automatic distributor (3) connects to the Web site (5) in order to consult the reduced content available and then, when so requested, the Web site (5) indicates to him the address of the supplier of content (6) from which the corresponding extracted contents are available. In fact, one could envisage having several suppliers of content. Likewise, one could envisage several Web sites (5) supplying reduced content.

In order to reduce the risks of fraud, one could subordinate the saving of a extracted content to the smartcard (2) to the prior purchase of operating rights for this content. In the above description, the identification of the user and holder of the smartcard (2) is effected by recognition of his identifier and his confidential code. Of course, one could also arrange for another method of identification.

The automatic distributor (3) could include a module for acquisition of the extracted contents by downloading from an extracted content supplier server, such as server 6.

1. A method for controlling access to a content by a terminal, comprising:
splitting (20b) the content into a first and a second part;
storing (21) the first part in the terminal (1);
saving (23) the second part in a memory located on a medium (2) outside the terminal (1);
connecting (24a) the said medium (2) to the terminal (1), and
reconstituting (25a) the content by combining the two parts.

2. A method according to claim 1, in which one reads off (20b), in a random manner, the values of bytes of the content and saves (23) in the memory of the medium (2) the read-off values of the bytes, forming the second part of the content, and their respective positions in the content.

3. A method according to claim 1, in which one reads off, in a targeted manner, the values of bytes of the content, and saves in the memory of the medium the read-off values of the bytes, forming the second part of the content, and their respective positions in the content.

4. A method according to claim 2, in which one deletes the bytes whose values have been read off in the original content, in order to obtain the first part of the content.

5. A method according to claim 2, in which one modifies the values of the bytes read off in the original content in order to obtain the first part of the content.

6. A method according to claim 1, in which
a holder of the said medium (2) acquires operating rights (22) for the content and
before reconstituting the content from the two content parts, one verifies (24e) the validity of the operating rights and authorises the reconstitution of the content only if the operating rights are valid.

7. A method according to claim 6, in which a network address of a operating-rights server(4) is saved in the memory of the medium (2) and, in order to verify the validity of the operating rights, the terminal (1) connects to the rights server (4) over the network (9).

8. A method according to claim 1, in which the terminal (1) retrieves the first part of the content in accordance with one of the following methods:
by downloading (21) of the first part from an information site (5) over a network of the IP type,
by reading the first part from an external medium,
by receipt of an electronic message containing the first part of the content.

9. A method according to claim 1, in which one inserts the medium (2) into an automatic distributor (3) which saves the second part of the content in the memory of the medium (2).

10. A method according to claim 1, in which one saves the second part of the content in the memory of the medium (2) at the end of manufacture of the said medium.

11. A method according to claim 1, in which one scrambles (20a) the content before it is split into two parts and one saves (23c) an unscrambling key in the memory of the medium (2).

12. A method according to claim 1, in which one scrambles the second part of the content and one saves a unscrambling key in the memory of the medium (2).

13. A terminal for implementation of the method of claim 1, including means (130) for acquiring a first part of a content, means (12) for reading from an external memory medium (2) and means (132) for reconstituting the said content by combination of the first part of the content and a second part of the content extracted from the memory of the medium (2).

14. A terminal according to claim 13, in which means (133) are provided to acquire operating rights associated with the content and means (131) to connect to a operating-rights server in order to verify the validity of the operating rights, intended to control the means (132) in order to reconstitute the content.

15. A terminal according to claim 13, in which the means (130) to acquire the first part of the content are arranged to acquire this first part in accordance with at least one of the following methods:
by downloading the first part from an information site (5) over a network of the IP type,
by reading the first part from an external medium,
by receipt of an electronic message containing the first part of the content.

16. A content operating-rights server, for implementation of the method of claim 1, including a user database (40) containing, for each user, user identification data and operating rights for the user, associated with at least one content, means (44) to connect to a network (9), and means (42) for authorisation of use, arranged so that on receipt of a request from a user terminal, it verifies the validity of the operating rights for the said user, associated with a given content, in order to authorise or interdict the use of the said content.

17. An automatic distributor of second content parts, for implementation of the method of claim 1, including means for acquiring second content parts, means for a man-machine interface (32) arranged so as to enable a user to select one of the second content parts, and means (31) to save the second selected part of the content to a memory of a external memory medium (2).

18. An automatic distributor according to claim 17, in which the means to acquire second content parts include means for connection to a local database (30) containing a multiplicity of second content parts.

19. An automatic distributor according to claim 17, in which the means to acquire second content parts are arranged so as to download the second content parts from a supplier server of second content parts, over a network.

20. An automatic distributor according to claim 17, in which means are provided for connection to a operating-rights server, in order to enable a user to purchase operating rights from the rights server by means of the automatic distributor.

21. A supplier server of content parts, for implementation of the method of claim 1, including a content database (60) containing a multiplicity of content, means (62) to split each content in the date base (60) into a first and a second content part, and the means (63) for transmission of the said first and second parts.

22. A data medium for implementation of the method of claim 1, intended to contain one part of a content used to reconstitute the said content.

23. A data medium according to claim 22, intended to contain the positions of bytes of the content whose values have been read off and which form the said part of the content, and the positions of the bytes used to reconstitute the said content.

24. A data medium according to claim 22, intended to contain data used to unscramble the content part, in the event that the said content part is scrambled.

25. A system for implementation of the method of claim 1, including
a content parts supplier (6) located in a first network (8) and intended to split content into a first and a second part;
at least one automatic distributor (3), intended to receive second content parts transmitted by the said supplier (6) over the first network (8) and to distribute the second content parts, stored on data media, to users, and
at least one terminal (1) for reading content intended to store the first part of a content, to read an external data medium in order to extract from it the second part of the said content and to combine the first and the second parts of the content in order to reconstitute the said content.

26. A system according to claim 25, in which an operating-rights server (4) is provided, intended to attribute operating rights associated with content to the holders of data media.

27. A system according to claim 25, in which site information (5) is provided, located on a second network (9), and intended to transmit first content parts to reading terminals over the second network (9).
